(19) United States
(12) Patent Application Publication
(10) Pub. No.: US 2023/0237694 A1
(43) Pub. Date: Jul. 27, 2023

(54) METHOD AND SYSTEM FOR DETECTING CHILDREN'S SITTING POSTURE BASED ON FACE RECOGNITION OF CHILDREN

(71) Applicants: ZHEJIANG LINGCHUANG NETWORK TECHNOLOGY CO., LTD., Hangzhou City (CN); DONGSHENG SHENZHOU TOURISM MANAGEMENT CO., LTD., Ningbo City (CN)

(72) Inventor: Shuicai HUANG, Hangzhou City (CN)

(21) Appl. No.: 18/296,128

(22) Filed: Apr. 5, 2023

Related U.S. Application Data
(63) Continuation of application No. PCT/CN2022/113474, filed on Aug. 19, 2022.

(30) Foreign Application Priority Data
Sep. 17, 2021 (CN) 202111091928.1

(51) Int. Cl. G06T 7/73; G06V 40/16

(52) U.S. Cl. CPC G06T 7/73; G06V 40/161; G06V 40/168

(57) ABSTRACT

A method and system for detecting children’s sitting posture based on face recognition of children are provided in the disclosure, which relates to the technical field of children’s sitting posture correction. By automatically identifying children’s ages, real-time detection and intelligent supervision can be performed on children’s sitting posture according to different ages of the children. According to the disclosure, the human bone relation information can be obtained only by simply and comprehensively calculating bone position information of several key parts of the human body, such as eyes, shoulders, nose, legs, knees, feet and the like, and then the sitting posture condition of the human body can be determined by comparing the human bone relation information with a corresponding set threshold. It is not necessary to carry out separate model training on sitting postures, but only to measure key data, which greatly decreases time and accuracy of sitting posture detection.

### TECHNICLAL FIELD

The disclosure relates to the technical field of children’s sitting posture correction, in particular to a method and a system for detecting children’s sitting posture based on face recognition of children.

### BACKGROUND ART

In recent years, a number of children with myopia and kyphosis caused by improper sitting posture is gradually increasing, and the improper sitting posture is one of main reasons for children’s vision decline, which is very harmful to children’s healthy development. Many children don’t have correct awareness of sitting posture, which needs adults’ reminding all the time. Therefore, there is an urgent need for a method or device for detecting whether a sitting posture is correct.

At present, products available in the market for correcting children’s sitting posture are mostly wearable type products, which often require users to respond to requirements of the device and cooperate with the device for testing, which is difficult for the children to completely cooperate with the device for testing, due to their characteristics of small skeleton and ease of movement. Moreover, existing device for correcting children’s sitting posture needs to be worn, which is not easily accepted by the children. In addition, with existing sitting posture measurement methods, good results may not be achieved in some specific situations, such as a situation in which children’s lower body is mostly blocked in doing homework.

### SUMMARY

An object of the present disclosure is to solve above problems mentioned in the background art, and to provide a method and a system for detecting children’s sitting posture based on face recognition of children.

In order to achieve the above object, a method for detecting children’s sitting posture based on face recognition of children is firstly provided in the present disclosure, which includes: collecting an image of a target area to obtain a target image; performing face detection on the target image; performing feature value extraction on a face with a preset facial feature model so to obtain a face template when the face is detected; matching the face template with a preset or trained face data set; obtaining human bone position information in the target image when the face template is matched with data of a first face data set in the face data set; obtaining human bone relation information according to the human bone position information; determining a human body position condition in the target image according to the human bone relation information; and determining a sitting posture condition of a human body according to the human bone relation information when the human body in the target image is in a sitting posture.

Optionally, the determining the sitting posture condition of the human body according to the human bone relation information specifically includes: obtaining left-right shoulder relation information according to bone coordinates at left and right shoulders of the human body; obtaining a left-right shoulder inclination angle according to the left-right shoulder relation information; and determining the sitting posture condition of the human body according to the left-right shoulder inclination angle.

Optionally, when the left-right shoulder inclination angle exceeds a corresponding set threshold, a current sitting posture condition of the human body is determined to be abnormal and a reminder message is generated for reminding.

Optionally, the method further includes: acquiring an age interval of the face template matched with the first face data set; determining the current sitting posture condition is abnormal when the face template is located in a first age interval and the left-right shoulder inclination angle exceeds a first set threshold; determining the current sitting posture condition is abnormal when the face template is located in a second age interval and the left-right shoulder inclination angle exceeds a second set threshold; and determining the current sitting posture condition is abnormal when the face template is located in a third age interval and the left-right shoulder inclination angle exceeds a second set threshold.

Optionally, the determining the sitting posture condition of the human body according to the human bone relation information specifically includes: obtaining binocular relation information according to bone coordinates at both eyes of the human body; obtaining a left-right eye inclination angle according to the binocular relation information; and determining the sitting posture condition of the human body according to the left-right eye inclination angle.

Optionally, determining the human body position condition in the target image according to the human bone relation information includes: obtaining hipbone-patella relation information and patella-foot bone relation information according to bone coordinates at hipbone, patella and foot bone; and determining whether the human body is in a sitting or standing posture according to the hipbone-patella relation information and the patella-foot bone relation information.

Optionally, determining the human body position condition in the target image according to the human bone relation information includes: obtaining left-right shoulder relation information according to bone coordinates at left and right shoulders of the human body; and determining whether the human body is in a sitting or lying posture according to the left-right shoulder relation information.

Optionally, when a plurality of faces are detected, face segmentation is performed on the plurality of faces to form an image of a single face. Then the image of the single face is segmented to form a plurality of face sub-regions. Weight pruning is performed on wrinkles, eye corners, eye bags and other age-differentiated parts.

Optionally, the first face data set is a face data set for 4 to 16 years old, and the second face data set is a face data set for over 16 years old.

A system for detecting children’s sitting posture based on face recognition of children is further provided in the present disclosure, which includes an image collecting module configured to collect an image of a target area to obtain a target image; a face detection module configured to perform face detection on the target image; a feature extraction module configured to perform feature value extraction on a face with a preset facial feature model so to obtain a face template when the face is detected; a face matching module configured to match the face template with a preset or trained face data set; a human bone position information acquisition module configured to obtain human bone position information in the target image when the face template is matched with data of a first face data set in the face data set; a human bone relation information acquisition module configured to obtain human bone relation information according to the human bone position information; a human body position condition determination module configured to determine a human body position condition in the target image according to the human bone relation information; a human body sitting posture condition determination module configured to determine a sitting posture condition of a human body according to the human bone relation information when the human body in the target image is in a sitting posture.

The disclosure has advantages as follows:

With the method and system for detecting children’s sitting posture based on face recognition of children according to the embodiment of the disclosure, children’s ages can be automatically identified, and real-time detection and intelligent supervision can be performed on children’s sitting posture according to different ages of the children. According to the embodiment of the disclosure, the human bone relation information can be obtained only by simply and comprehensively calculating bone position information of several key parts of the human body, such as eyes, shoulders, nose, legs, knees, feet and the like, and then the sitting posture condition of the human body can be determined by comparing the human bone relation information with a corresponding set threshold. Compared with existing methods that need to use high-order feature vectors, integral calculation, etc., it is not necessary to carry out separate model training on sitting postures, but only to measure key data, which greatly decreases time and accuracy of sitting posture detection.

Features and advantages of the present disclosure will be described in detail by examples with reference to accompanying drawings.

### BRIEF DESCRIPTION OF THE DRAWINGS

FIG. 1 is a flow chart of a method for detecting children’s sitting posture based on face recognition of children according to an embodiment of the present disclosure;

FIG. 2 is a flow chart of another method for detecting children’s sitting posture based on face recognition of children according to an embodiment of the present disclosure;

FIG. 3 is a flow chart of another method for detecting children’s sitting posture based on face recognition of children according to an embodiment of the present disclosure;

FIG. 4 is a flow chart of another method for detecting children’s sitting posture based on face recognition of children according to an embodiment of the present disclosure;

FIG. 5 is a flow chart of another method for detecting children’s sitting posture based on face recognition of children according to an embodiment of the present disclosure;

FIG. 6 is a flow chart of another method for detecting children’s sitting posture based on face recognition of children according to an embodiment of the present disclosure;

FIG. 7 is a flow chart of another method for detecting children’s sitting posture based on face recognition of children according to an embodiment of the present disclosure; and

FIG. 8 is a block diagram of a system for detecting children’s sitting posture based on face recognition of children according to an embodiment of the present disclosure.

### DETAILED DESCRIPTION

In order to facilitate understanding of those skilled in the art, the present disclosure will be further described in detail below with reference to specific embodiments.

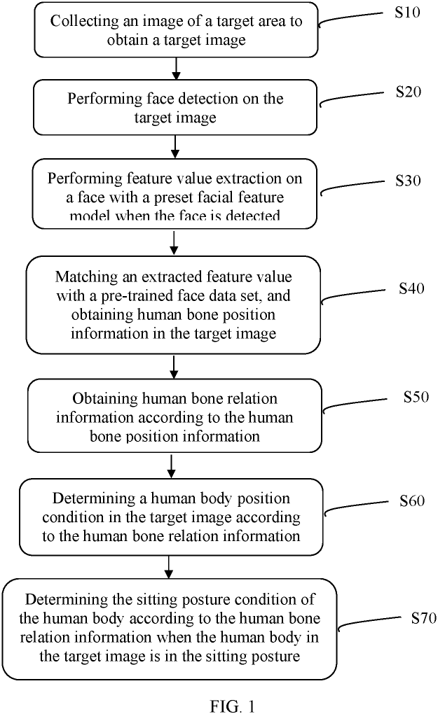

Referring to FIG. 1, a method for detecting children’s sitting posture based on face recognition of children is provided in an embodiment of the present disclosure, which includes following steps S10 to S70.

In step S10, an image of a target area to obtain a target image is collected.

In this embodiment, image collection is made by recording an image within a certain range from the screen terminal with one or more cameras, so as to generate target image information. The camera can be integrated into the screen terminal or placed outside of the screen. The camera is connected with a processing unit, and is configured to send the collected target image to the processing unit for subsequent series of processing. Specifically, the camera can be connected with the processing unit in a wired or wireless way for corresponding data transmission. The processing unit can be a processor integrated in the screen terminal or a processor in a central control device of Internet of Things.

In step S20, face detection is performed on the target image.

A purpose of the face detection is to get any frame of the target image. The target image is searched with face detection algorithm to determine whether there is a face in the target image, because the target image may contain objects that are not faces, such as indoor furniture and other parts of a person (such as legs, shoulders and arms).

The face detection algorithm built in the processing unit can be configured to perform face detection on any frame of the target image. If there is a face in this frame, subsequent steps such as face feature extraction can be carried out. The face detection algorithm can be realized by using a classifier with OpenCV. OpenCV is an open source cross-platform computer vision library, which can be operated on Linux, Windows, Android and other operating systems, and can be used for image processing and development of computer vision applications.

In this embodiment, a yolo-based face detection algorithm is adopted for face detection. The target image is cut into 49 image blocks, and then each of the image blocks is measured to determine a face position. In addition, the yolo-based face detection algorithm is configured to cut the target image into 49 image blocks, key parts such as eyelids can be refined in a subsequent feature extraction stage, thus improving accuracy of face feature extraction and face matching.

In other embodiments, a histogram of oriented gradient is adopted to detect the face position. Firstly, the target image is grayed, and then gradient of pixels in the image is calculated. The face position can be detected and obtained by converting the image into the histogram of oriented gradient.

In step S30, feature value extraction is performed on a face with a preset facial feature model when the face is detected.

In this embodiment, weight pruning is performed on age-differentiated parts such as wrinkles, eye-corners, eye bags, etc. on the face through a yolo-based darknet deep learning framework, thus realizing extraction of facial feature values.

In other embodiments, the pre-trained face feature model is adopted to perform feature value extraction on the face image to obtain the face template. The pre-trained face feature model can be obtained by calling a face recognition algorithm with the Facerecognizer class in OpenCV, such as Eigenfaces algorithm or Fisherfaces algorithm, which provides a general interface for the face recognition algorithm.

In step S40, an extracted feature value is matched with a pre-trained face data set, and when the feature value is matched with a first face data set in the face data set, human bone position information in the target image is obtained.

A feature regression method can be adopted to train with all the face feature values in the face data set. In a training result, the face data set is divided into the first face data set and a second face data set by attributes, and then matching is performed though a face attribute recognition method. In this embodiment, the first face data set is a face data set for 4 to 16 years old, and the second face data set is a face data set for over 16 years old.

In other embodiments, the first face data set is a face data set for 4 to 12 years old, and the second face data set is a face data set for over 12 years old.

In this embodiment, the face data set for 4 to 16 years old is adopted to avoid a situation that some children are excluded by the face recognition system for children because their faces are mature and their actual age is less than their appearance age.

For application scenarios where children need to be classified according to a smaller age interval so as to carry out more refined and differentiated control, all of the face feature values in the face data set are trained to be divided into several face data sets with different intervals, and then children of different ages are measured differently. Specifically, by using a face recognition method and by calculating an Euclidean distance between the target face and a weight vector of a respective person in the face database, children of different ages can be identified more accurately.

By matching feature values of the face in the target image with the first face data set, it can be determined that a face subject in the obtained target image belongs to an age interval represented by the first face data set.

In this embodiment, the children are aged 4 to 16 years, which are subject for sitting posture detection in embodiments of the disclosure.

If there is no match, the face subject in the target image may be an adult over 16 years old or a child under 4 years old, which does not fall within a scope for sitting posture detection in the embodiment of the present disclosure.

When that face subject in the target image is within an age interval represented by the first face data set, the human bone position information in the target image is obtained. The human bone position information is world coordinates of key parts of a human body.

In step S50, human bone relation information is obtained according to the human bone position information.

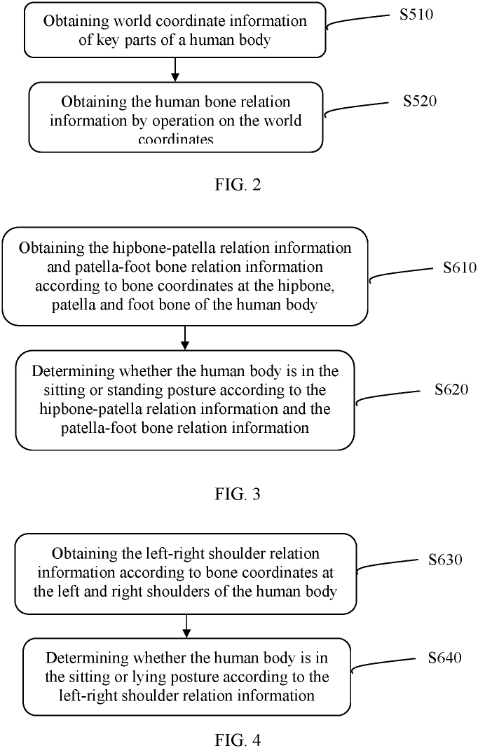

Refer to FIG. 2, a step in which the human bone relation information is obtained according to the human bone position information specifically includes following steps S510 and S520.

In S510, world coordinate information of key parts of a human body is obtained, such as world coordinates of a shoulder, an eye, a nose tip and other parts.

In step S520, the human bone relation information is obtained by operation on the world coordinates, for example using skeleton estimation algorithms such as Openpose or Convective Pose Machines. In this embodiment, by calculating abscissa difference between the left and right shoulders, a relationship between the left and right shoulders is calculated as first human bone relation information.

In other embodiments, world coordinates of any number of bone positions can be selected to obtain the human bone relation information, for example, binocular relation information can be obtained according to bone coordinates of both human eyes, and hipbone-patella relation information and patella-foot bone relation information can be obtained according to bone coordinates of the hipbone, patella and foot bone of the human body.

In step S60, a human body position condition in the target image is determined according to the human bone relation information.

Referring to FIG. 3, a standing posture is excluded from three human body position conditions, namely, the standing posture, a sitting posture and a lying posture, through the hipbone-patella relation information and patella-foot bone relation information, which includes following steps S610 to S620.

In step S610, the hipbone-patella relation information and patella-foot bone relation information are obtained according to bone coordinates at the hipbone, patella and foot bone of the human body.

In step S620, it is determined whether the human body is in the sitting or standing posture according to the hipbone-patella relation information and the patella-foot bone relation information. Specifically, when a distance from the hipbone to a patella is greater than or slightly smaller than a distance from the patella to the foot bone, it can be determined that the human body is in a standing posture, and when it is detected that the distance from the hipbone to the patella is far smaller than the distance from the patella to the foot bone, it can be determined that the human body is in a sitting posture.

Referring to FIG. 4, the lying posture is excluded from two human body posture, the sitting posture and the lying posture by left-right shoulder relation information, which includes following steps S630 to S640.

In step S630, the left-right shoulder relation information is obtained according to bone coordinates at the left and right shoulders of the human body.

In step S640, it is determined whether the human body is in the sitting or lying posture according to the left-right shoulder relation information. When the human body lies down, both shoulders are almost flush with each other, so when difference in ordinates of the left and right shoulders is less than one shoulder width, it can be determined that the human body is in the lying posture. When difference in ordinates of the left and right shoulders is greater than one shoulder width, it can be determined that the human body is in the sitting posture. In addition, when a lower body is not present, a child is considered to be in the sitting posture.

In step S70, the sitting posture condition of the human body is determined according to the human bone relation information when the human body in the target image is in the sitting posture.

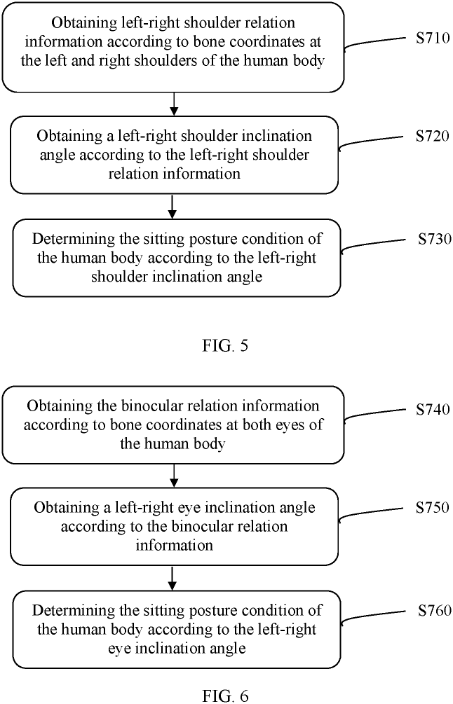

Referring to FIG. 5, a step in which the sitting posture condition of the human body is determined according to the left-right shoulder relation information in the human bone relation information specifically includes following steps S710 to S730.

In step S710, the left-right shoulder relation information is obtained according to bone coordinates at the left and right shoulders of the human body.

In step S720, a left-right shoulder inclination angle is obtained according to the left-right shoulder relation information, with a specific calculation formula of: a left-right shoulder inclination angle

$$\begin{matrix}= arctan \\ \left(\frac{\left|\text{ordinate} \text{of} \text{left} \text{shoulder} - \text{ordinate} \text{of} \text{right} \text{shoulder}\right|}{\left|\text{abscissa} \text{of} \text{left} \text{shoulder} \text{−} \text{abscissa} \text{of} \text{right} \text{shoulder}\right|}\right) ∗ \frac{180}{π} .\end{matrix}$$

In step S730, the sitting posture condition of the human body is determined according to the left-right shoulder inclination angle. In addition, when the left-right shoulder inclination angle exceeds a corresponding set threshold, a current sitting posture condition of the human body is determined to be abnormal and a reminder message is generated for reminding.

Referring to FIG. 6, a step in which the sitting posture condition of the human body is determined according to binocular relation information in the human bone relation information specifically includes following steps S740 to S760.

In step S740, the binocular relation information is obtained according to bone coordinates at both eyes of the human body.

In the S750, a left-right eye inclination angle is obtained according to the binocular relation information. And the calculation formula of left-right eye inclination angle is: a left-right eye inclination angle = arctan

$$\left(\frac{\left|\text{ordinate of left eye - ordinate of right eye}\right|}{\left|\text{abcissa of left eye - abscissa of right eye}\right|}\right) ∗ \frac{180}{π} .$$

In the S760, the sitting posture condition of the human body is determined according to the left-right eye inclination angle.

In other embodiments, the human body may be disturbed by environmental reasons such as occlusion, such as hand occlusion, bowing of a head, etc. In this case, a streaming camera may not be able to obtain face information. At this time, a method of target tracking can be used to automatically identify a person as a target when captured face information is confirmed to be the target, and automatically follow the target in a short time, and analyze a sitting posture of the person in real time. It solves a problem of sitting posture detection in a case of incomplete human bone features.

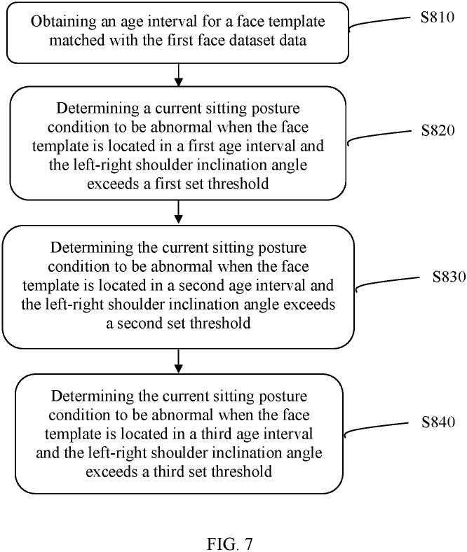

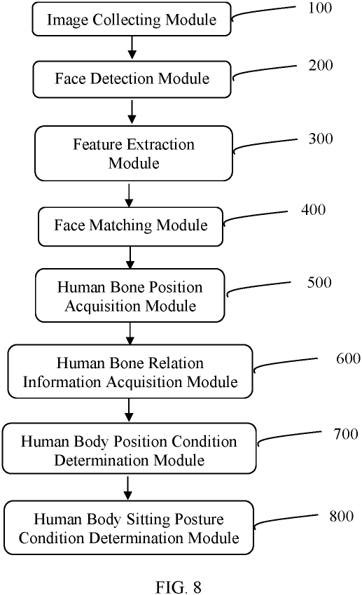

The method for detecting children’s sitting posture based on face recognition of children in the embodiment of the present disclosure also provides technical schemes of differentiated supervision by different ages of children, so that it is suitable for a current situation that there is a plurality of children of different ages in a family, and sitting postures of the children of different ages can be supervised to different degrees. For specific steps, reference can be made to FIG. 7.

In step S810, an age interval for a face template matched with the first face dataset data is obtained.

In step S820, a current sitting posture condition is determined to be abnormal when the face template is located in a first age interval and the left-right shoulder inclination angle exceeds a first set threshold.

In step S830, the current sitting posture condition is determined to be abnormal when the face template is located in a second age interval and the left-right shoulder inclination angle exceeds a second set threshold.

In step S840, the current sitting posture condition is determined to be abnormal when the face template is located in a third age interval and the left-right shoulder inclination angle exceeds a third set threshold.

Specifically, when a child’s age is between 6 and 8 years old, and the left-right shoulder inclination angle exceeds 30°, it can be determined to be an abnormal sitting posture, and it can be set that the child sits for 20 minutes and then gets up and walks for 15 minutes. When a child’s age is between 10 and 12 years old, and the left-right shoulder inclination angle exceeds 20°, it can be determined to be an abnormal sitting posture, and it can be set that the child sits for 45 minutes and then gets up and walks for 10 minutes.

With the method for detecting children’s sitting posture based on face recognition of children according to the embodiment of the disclosure, children’s ages can be automatically identified, and real-time detection and intelligent supervision can be performed on children’s sitting posture according to different ages of the children. According to the embodiment of the disclosure, the human bone relation information can be obtained only by simply and comprehensively calculating bone position information of several key parts of the human body, such as eyes, shoulders, nose, legs, knees, feet and the like, and then the sitting posture condition of the human body can be determined by comparing the human bone relation information with a corresponding set threshold. Compared with existing methods that need to use high-order feature vectors, integral calculation, etc., it is not necessary to carry out separate model training on sitting postures, but only to measure key data, which greatly decreases time and accuracy of sitting posture detection.

In addition, based on the method for detecting children’s sitting posture based on face recognition of children, a system for detecting children’s sitting posture based on face recognition of children is further provided in an embodiment of the present disclosure. As shown in FIG. 8, the system includes an image collecting module 100, an image acquisition module 200, a feature extraction module 300, a face matching module 400, a human bone position information acquisition module 500, a human bone relation information acquisition module 600, a human body position condition determination module 700 and a human body sitting posture condition determination module 800.

The image collecting module 100 is configured to collect an image of a target area to obtain a target image.

The face detection module 200 is configured to perform face detection on the target image.

The feature extraction module 300 is configured to perform feature value extraction on a face with a preset facial feature model when the face is detected.

The face matching module 400 is configured to match the face template with a preset or trained face data set.

The human bone position information acquisition module 500 is configured to obtain human bone position information in the target image when the face template is matched with data of a first face data set in the face data set.

The human bone relation information acquisition module 600 is configured to obtain human bone relation information according to the human bone position information.

The human body position condition determination module 700 is configured to determine a human body position condition in the target image according to the human bone relation information.

The human body sitting posture condition determination module 800 is configured to determine a sitting posture condition of a human body according to the human bone relation information when the human body in the target image is in a sitting posture.

To sum up, a system for detecting children’s sitting posture based on face recognition of children is provided in the embodiment of the present disclosure, which can be implemented as a program and executed on a computer device. Various program modules that make up the system for detecting children’s sitting posture based on face recognition of children can be stored in a memory of the computer, such as the image collecting module 100, the image acquisition module 200, the feature extraction module 300, the face matching module 400, the human bone position information acquisition module 500, the human bone relation information acquisition module 600, the human body position condition determination module 700 and the human body sitting posture condition determination module 800 as shown in FIG. 8. The program composed of respective program modules causes the processor to execute steps in a method for detecting children’s sitting posture based on face recognition of children in various embodiments of the present disclosure described in this specification.

The above embodiments are illustrative, but not restrictive, of the present disclosure, and any simple transformation of the present disclosure falls within protection scope of the present disclosure. The above are only preferred embodiments of the present disclosure, and the protection scope of the present disclosure is not limited to the above embodiments. All technical solutions under idea of the present disclosure belong to the protection scope of the present disclosure. It should be pointed out that some improvements and modifications can be made by those of ordinary skilled in the art without departing from technical principle of the present disclosure, which should also be regarded to be within the protection scope of the present disclosure.

1. A method for detecting children’s sitting posture based on face recognition of children, comprising: collecting, by one or more cameras, an image of a target area to obtain a target image; performing, by a processor connected with the one or more cameras, face detection on the target image; performing, by the processor, feature value extraction on a face with a preset facial feature model so to obtain a face template when the face is detected; matching, by the processor, the face template with a preset or trained face data set; obtaining, by the processor, human bone position information in the target image when the face template is matched with data of a first face data set in the face data set; obtaining, by the processor, human bone relation information according to the human bone position information; determining, by the processor, a human body position condition in the target image according to the human bone relation information; and determining, by the processor, a sitting posture condition of a human body according to the human bone relation information when the human body in the target image is in a sitting posture.

2. The method for detecting children’s sitting posture based on face recognition of children according to claim 1, wherein the determining, by the processor, the sitting posture condition of the human body according to the human bone relation information specifically comprises: obtaining left-right shoulder relation information according to bone coordinates at left and right shoulders of the human body; obtaining a left-right shoulder inclination angle according to the left-right shoulder relation information; and determining the sitting posture condition of the human body according to the left-right shoulder inclination angle.

3. The method for detecting children’s sitting posture based on face recognition of children according to claim 2, wherein when the left-right shoulder inclination angle exceeds a corresponding set threshold, a current sitting posture condition of the human body is determined to be abnormal and a reminder message is generated for reminding, by the processor.

4. The method for detecting children’s sitting posture based on face recognition of children according to claim 3, further comprising: acquiring, by the processor, an age interval of the face template matched with the first face data set; determining, by the processor, the current sitting posture condition is abnormal when the face template is located in a first age interval and the left-right shoulder inclination angle exceeds a first set threshold; determining, by the processor, the current sitting posture condition is abnormal when the face template is located in a second age interval and the left-right shoulder inclination angle exceeds a second set threshold; and determining, by the processor, the current sitting posture condition is abnormal when the face template is located in a third age interval and the left-right shoulder inclination angle exceeds a second set threshold.

5. The method for detecting children’s sitting posture based on face recognition of children according to claim 1, wherein the determining, by the processor, the sitting posture condition of the human body according to the human bone relation information specifically comprises: obtaining binocular relation information according to bone coordinates at both eyes of the human body; obtaining a left-right eye inclination angle according to the binocular relation information; and determining the sitting posture condition of the human body according to the left-right eye inclination angle.

6. The method for detecting children’s sitting posture based on face recognition of children according to claim 1, wherein the determining, by the processor, the human body position condition in the target image according to the human bone relation information comprises: obtaining hipbone-patella relation information and patella-foot bone relation information according to bone coordinates at hipbone, patella and foot bone; and determining whether the human body is in a sitting or standing posture according to the hipbone-patella relation information and the patella-foot bone relation information.

7. The method for detecting children’s sitting posture based on face recognition of children according to claim 1, wherein the determining, by the processor, the human body position condition in the target image according to the human bone relation information comprises: obtaining left-right shoulder relation information according to bone coordinates at left and right shoulders of the human body; and determining whether the human body is in a sitting or lying posture according to the left-right shoulder relation information.

8. The method for detecting children’s sitting posture based on face recognition of children according to claim 1, wherein when a plurality of faces are detected by the processor, face segmentation is performed on the plurality of faces to form an image of a single face; then the image of the single face is segmented to form a plurality of face sub-regions; and weight pruning is performed on wrinkles, eye corners, eye bags and other age-differentiated parts.

9. The method for detecting children’s sitting posture based on face recognition of children according to claim 1, wherein the first face data set is a face data set for 4 to 16 years old, and the second face data set is a face data set for over 16 years old.

10. A system for detecting children’s sitting posture based on face recognition of children, comprising: a computer device, wherein various program modules can be stored in a memory of the computer device and executed on the computer device;
an image collecting module configured to collect an image of a target area to obtain a target image;
a face detection module configured to perform face detection on the target image;
a feature extraction module configured to perform feature value extraction on a face with a preset facial feature model when the face is detected;
a face matching module configured to match the face template with a preset or trained face data set;
a human bone position acquisition module configured to obtain human bone position information in the target image when the face template is matched with a first face data set in the face data set;
a human bone relation information acquisition module configured to obtain human bone relation information according to the human bone position information;
a human body position condition determination module configured to determine a human body position condition in the target image according to the human bone relation information; and
a human body sitting posture condition determination module configured to determine a sitting posture condition of a human body according to the human bone relation information when the human body in the target image is in a sitting posture.
